(19) United States
(12) Patent Application Publication
(10) Pub. No.: US 2025/0253763 A1
(43) Pub. Date: Aug. 7, 2025

(54) CONVERTER SYSTEM AND CONVERTER DRIVING METHOD

(71) Applicant: HONDA MOTOR CO., LTD., Tokyo (JP)

(72) Inventors: Ryota KITAMOTO, Saitama (JP); Haruei KOKUHO, Saitama (JP)

(21) Appl. No.: 19/014,508

(22) Filed: Jan. 9, 2025

(30) Foreign Application Priority Data
Feb. 6, 2024 (JP) 2024-016493

(51) Int. Cl. H02M 1/36; H02M 1/00; H02M 1/14; H02M 1/32

(52) U.S. Cl. CPC H02M 1/36; H02M 1/0009; H02M 1/14; H02M 1/32

(57) ABSTRACT

A converter system includes: a first power supply path connecting a power supply and a load; a converter provided on the first power supply path; a contactor provided between the converter and the load, the contactor including a normally open movable contact for selectively establishing/interrupting the first power supply path and an electromagnetic coil for driving the movable contact; a contactor driving circuit electrically connected to the electromagnetic coil to drive the contactor; a current sensor for detecting a contactor drive current flowing from the contactor driving circuit to the electromagnetic coil; and a controller for controlling the converter and the contactor driving circuit. The controller stops operation of the converter in a case where the contactor drive current becomes undetected by the current sensor during operation of the converter.

### TECHNICAL FIELD

The present invention relates to a converter system and a converter driving method in the converter system.

### BACKGROUND ART

In recent years, efforts to realize a low-carbon society or a carbon-neutral society are becoming more active, and in relation to vehicles, research and development on electrification technology are being conducted to reduce CO₂ emission and to improve energy efficiency. To improve the driving performance of electric vehicles, it is important to stably supply electric power from the power supply to the load such as an electric motor, an inverter, or the like.

To prevent excessive electric power from being supplied to the load when any abnormality occurs in the electric circuit, a contactor is provided in the power supply path. Further, to smooth the electric power supplied to the load, a smoothing capacitor is provided in the power supply path.

For example, JP7120072B2 discloses a converter system in which a main contactor is provided in a power supply path from a battery to a DC/DC converter, which is a load, and a smoothing capacitor is connected in parallel with the load. This system includes a precharge contactor connected in parallel with the main contactor via a resistor, voltage sensors for detecting the voltages of the battery and the capacitor, respectively, a current sensor for detecting electric current flowing from the battery to the load, and a control unit. The control unit controls precharge of the capacitor by opening and closing the precharge contactor and also controls opening and closing of the main contactor. The control unit determines that the precharge is completed when the current detected by the current sensor is less than or equal to a threshold current.

Incidentally, in a system in which the contactor is provided between the converter and the load, supply of electric power from the contactor driving circuit to the contactor may stop for some reason so that an open failure in which the contactor is inadvertently opened may occur. When an open failure of the contactor occurs, the output voltage of the converter can become excessive. Therefore, an overvoltage threshold for stopping the converter is set for the output voltage of the converter detected by the voltage sensor.

However, if the converter output is stopped after the output voltage of the converter exceeds the overvoltage threshold after occurrence of the open failure of the contactor, there is a stop delay of a certain time from the time point when the output voltage exceeds the overvoltage threshold to when the converter output is stopped. Therefore, the output voltage of the converter can become higher than the overvoltage threshold. In other words, when an open failure of the contactor occurs, during a period from the time point when the output voltage of the converter exceeds the overvoltage threshold to when the stop operation of the converter is completed, the converter continues to output the voltage, and the output voltage of the converter can become excessive. Therefore, if the converter is not provided with a capacitor having a large capacitance, there is a possibility that electronic components including the capacitor may fail due to application of excessive voltage.

### SUMMARY OF THE INVENTION

In view of the foregoing background, a primary object of the present invention is to prevent the output voltage of the converter from becoming excessive when an open failure of the contactor occurs.

To achieve the above object, one aspect of the present invention provides a converter system (1), comprising: a first power supply path (4) connecting a power supply (2) and a load (5); a converter (3) provided on the first power supply path; a contactor (6) provided between the converter and the load in the first power supply path, the contactor including a normally open movable contact (13) for selectively establishing/interrupting the first power supply path and an electromagnetic coil (14) for driving the movable contact; a contactor driving circuit (15) electrically connected to the electromagnetic coil to drive the contactor; a current sensor (19) for detecting a contactor drive current flowing from the contactor driving circuit to the electromagnetic coil; and a controller (10) configured to control the converter and to control the contactor driving circuit so as to supply electric power to the electromagnetic coil to close the contactor when the converter is in operation and so as to stop the electric power supply to the electromagnetic coil to open the contactor when the converter is stopped, wherein the controller is configured to stop operation of the converter in a case where the contactor drive current becomes undetected by the current sensor during operation of the converter.

According to this aspect, since the operation of the converter is stopped in a case where the contactor drive current becomes undetected by the current sensor when electric current is outputted from the converter, the output voltage of the converter is prevented from becoming excessive.

In the above configuration, the contactor (6) comprises a first contactor (6A) provided on a positive power line of the first power supply path and a second contactor (6B) provided on a negative power line of the first power supply path, the contactor driving circuit (15) comprises a first contactor driving circuit (15A) for driving the first contactor and a second contactor driving circuit (15B) for driving the second contactor, and the current sensor (19) comprises a first current sensor (19A) for detecting a contactor drive current flowing from the first contactor driving circuit to the electromagnetic coil of the first contactor and a second current sensor (19B) for detecting a contactor drive current flowing from the second contactor driving circuit to the electromagnetic coil of the second contactor.

According to this aspect, since the first contactor and the second contactor are provided, even if one of the contactors is fixed in the closed state, it is possible to stop the electric power supply to the load by opening the other of the contactors. Also, when an open failure occurs in one of the contactors, the output voltage of the converter is prevented from becoming excessive because the operation of the converter is stopped in the case where the contactor drive current becomes undetected by the current sensor corresponding to the contactor in which the failure has occurred.

Also, to achieve the above object, another aspect of the present invention provides a converter driving method in a converter system (1), wherein the converter system comprises: a first power supply path (4) connecting a power supply (2) and a load (3); a converter (5) provided on the first power supply path; a contactor (6) provided between the converter and the load in the first power supply path (4), the contactor including a normally open movable contact (13) for selectively establishing/interrupting the first power supply path and an electromagnetic coil (14) for driving the movable contact; a contactor driving circuit (15) electrically connected to the electromagnetic coil to drive the contactor; and a current sensor (19) for detecting a contactor drive current flowing from the contactor driving circuit to the electromagnetic coil, the converter driving method comprising: controlling the contactor driving circuit so as to supply electric power to the electromagnetic coil to close the contactor when the converter is in operation and so as to stop the electric power supply to the electromagnetic coil to open the contactor when the converter is stopped; and stopping operation of the converter in a case where the contactor drive current becomes undetected by the current sensor during operation of the converter.

According to this aspect, since the operation of the converter is stopped in a case where the contactor drive current becomes undetected by the current sensor when electric current is outputted from the converter, the output voltage of the converter is prevented from becoming excessive.

According to the above aspect, it is possible to prevent the output voltage of the converter from becoming excessive when an open failure of the contactor occurs.

### BRIEF DESCRIPTION OF THE DRAWINGS

FIG. 1 is a block diagram showing a functional configuration of a converter system according to an embodiment;

FIG. 2 is a time chart showing an operation of the converter system according to the embodiment;

FIG. 3 is a block diagram showing a functional configuration of a converter system of a comparative example; and

FIG. 4 is a time chart showing an operation of the converter system of the comparative example.

### DETAILED DESCRIPTION OF THE INVENTION

In the following, an embodiment of the present invention will be described in detail with reference to the drawings. The following embodiment is described as an example in which the present invention is applied to an automobile. The automobile may be a hybrid car, a fuel cell vehicle, an electric car, or the like.

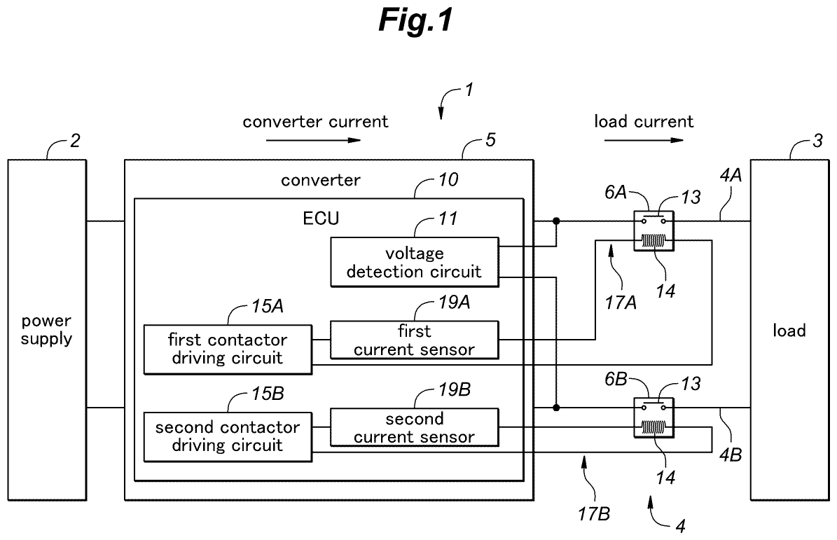

FIG. 1 is a block diagram showing a functional configuration of a converter system 1 according to the embodiment. As shown in FIG. 1, the converter system 1 includes a power supply 2, a load 3, and a first power supply path 4 (4A, 4B) connecting the power supply 2 and the load 3. A converter 5 is provided on the first power supply path 4, namely, between the power supply 2 and the load 3 in the first power supply path 4, and contactors 6 (6A, 6B) are provided between the converter 5 and the load 3 in the first power supply path 4. Namely, it can be said that the converter system 1 is a contactor system including the contactors 6.

The power supply 2 is composed of a power supply device mounted on the automobile. The power supply device may be a battery fixed to the automobile, a portable battery configured to be detachable from the automobile, a fuel cell, or the like. The battery may be a lithium ion battery, a nickel hydrogen battery, etc. The power supply 2 is a DC power supply that outputs DC electric power, and supplies DC electric power to the converter 5.

The load 3 is a traveling motor, an inverter, etc. of the automobile, for example. The traveling motor may be an AC motor or a DC motor provided with permanent magnets. In the case where the traveling motor is an AC motor, the load 3 includes a traveling motor and an inverter. The traveling motor functions as a drive motor when the automobile is power running and functions as an electric generator during braking of the automobile.

For example, the inverter may be configured as a three-phase bridge inverter. When the automobile is power running, DC electric power is supplied from the power supply 2 to the inverter via the converter 5. The inverter converts the DC electric power to three-phase AC electric power and supplies the AC electric power to the traveling motor. As a result of the driving of the traveling motor, the driving wheels are rotationally driven and the automobile travels.

The converter 5 is a DC/DC converter and includes an electronic control unit (ECU) 10 (one example of the controller). Further, in the converter 5, a capacitor for smoothing the output voltage is connected in parallel with the load 3. The ECU 10 controls the converter 5 to boost the DC electric power supplied from the power supply 2. As a result of the ECU 10 adjusting the output voltage to be applied to the load 3 to a desired value, the drive current supplied to the load 3 via the first power supply path 4 is adjusted.

On the other hand, when the traveling automobile is braked, the inverter is regeneratively operated so as to make the traveling motor function as an electric generator, and converts the AC electric power generated by the traveling motor to DC electric power. The high-voltage DC electric power converted by the inverter is stepped down via the converter 5 and is supplied to the power supply 2. Thereby, the power supply 2 is charged. As a result of the ECU 10 adjusting the charging voltage to be applied to the power supply 2 to a desired value, the charging electric current supplied to the power supply 2 is adjusted.

The ECU 10 consists of a computer including a processor (a processing unit such as a CPU, an MPU, etc.) and a memory (a storage device such as a ROM, a RAM, etc.) and is configured to execute various processes necessary to control the converter 5, etc. The processor is configured to read necessary data and software from the memory according to execution commands from external devices, such as an input device, and to execute predetermined computational processing according to the software. The ECU 10 may be configured as one piece of hardware or may be configured as a unit including multiple pieces of hardware.

Further, the ECU 10 is provided with a voltage detection circuit 11 for detecting the voltage outputted from the converter 5 to the first power supply path 4. The first power supply path 4 is configured by a positive power line 4A and a negative power line 4B. The voltage detection circuit 11 is connected to the positive power line 4A and the negative power line 4B of the first power supply path 4.

The ECU 10 stores a preset overvoltage threshold. When the detection result of the voltage detection circuit 11 exceeds the overvoltage threshold during operation of the converter 5, the ECU 10 determines that an abnormality occurs in the voltage outputted from the converter 5 to the load 3 and stops the converter 5. Note, however, that there is a stop delay of a predetermined time from the time point when the output voltage of the converter 5 exceeds the overvoltage threshold to when the converter 5 is actually stopped.

The contactors 6 are each an electromagnetic contactor for selectively establishing/interrupting the first power supply path 4, and in the present embodiment, two contactors 6 (hereinafter referred to as a first contactor 6A and a second contactor 6B) are provided. The first contactor 6A is provided in the positive power line 4A of the first power supply path 4, and the second contactor 6B is provided in the negative power line 4B of the first power supply path 4. Each contactor 6 includes a movable contact 13 (contact point) which can selectively take an open state and a closed state and an electromagnetic coil 14 for driving the movable contact 13. Each contactor 6 is a normally open electromagnetic contactor in which the movable contact 13 opens to interrupt the first power supply path 4 when the electromagnetic coil 14 is not energized, and the movable contact 13 is closed to establish the first power supply path 4 when the electromagnetic coil 14 is energized.

In the case where a contactor 6 is provided in the first power supply path 4, a malfunction in which the contactor 6 is fixed in the closed state may occur. In the present embodiment, since two contactors 6 including the first contactor 6A and the second contactor 6B are provided, even if one contactor 6 is fixed in the closed state, the electric power supply to the load 3 can be stopped by opening the other contactor 6.

Each contactor 6 is controlled by the ECU 10 of the converter 5. The ECU 10 includes a first contactor driving circuit 15A for driving the first contactor 6A and a second contactor driving circuit 15B for driving the second contactor 6B. The first contactor driving circuit 15A is electrically connected to the electromagnetic coil 14 of the first contactor 6A via a first contactor power supply path 17A. The second contactor driving circuit 15B is electrically connected to the electromagnetic coil 14 of the second contactor 6B via a second contactor power supply path 17B. Each contactor driving circuit 15A, 15B selectively applies a voltage to the electromagnetic coil 14 of the corresponding contactor 6 to control the contactor drive current flowing through the electromagnetic coil 14, thereby opening and closing the movable contact 13.

Further, the ECU 10 includes a first current sensor 19A for detecting the contactor drive current flowing from the first contactor driving circuit 15A to the corresponding electromagnetic coil 14 and a second current sensor 19B for detecting the contactor drive current flowing from the second contactor driving circuit 15B to the corresponding electromagnetic coil 14. The first contactor driving circuit 15A supplies the contactor drive current to the electromagnetic coil 14 to close the first contactor 6A when the converter 5 is in operation, and stops supplying the contactor drive current to the electromagnetic coil 14 to open the first contactor 6A when the converter 5 is stopped. The second contactor driving circuit 15B supplies the contactor drive current to the electromagnetic coil 14 to close the second contactor 6B when the converter 5 is in operation, and stops supplying the contactor drive current to the electromagnetic coil 14 to open the second contactor 6B when the converter 5 is stopped.

In a case where the contactor drive current becomes undetected by the first current sensor 19A during the operation of the converter 5, the ECU 10 determines, from the abnormality of the first contactor driving circuit 15A, that an open failure has occurred in the first contactor 6A, and stops the operation of the converter 5. Also, in a case where the contactor drive current becomes undetected by the second current sensor 19B during the operation of the converter 5, the ECU 10 determines, from the abnormality of the second contactor driving circuit 15B, that an open failure has occurred in the second contactor 6B, and stops the operation of the converter 5.

The converter system 1 is configured as described above. In the following, the operation and effects of the converter system 1 thus configured will be described.

Before describing the operation and effects of the converter system 1 according to the embodiment, the configuration and operation of a converter system 101 of a comparative example is described.

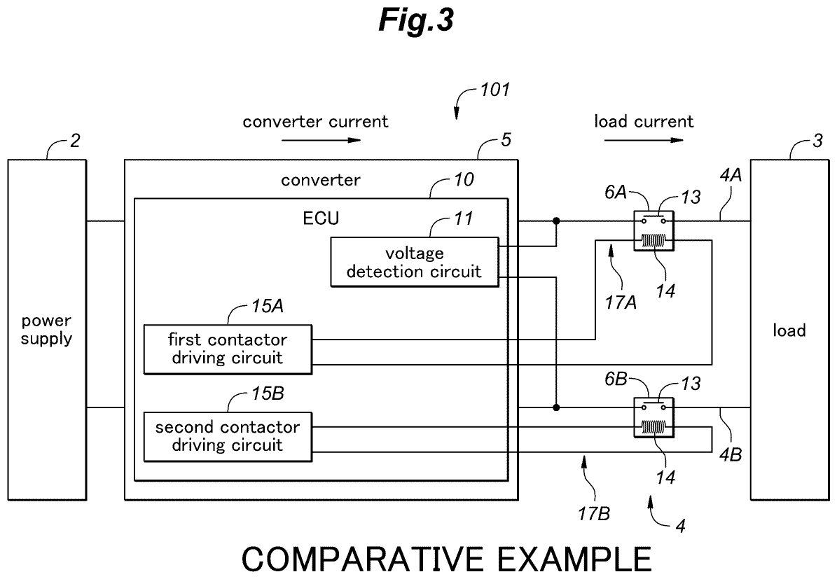

FIG. 3 is a block diagram showing a functional configuration of the converter system 101 according to the comparative example. Note that the elements same as or similar to those of the converter system 1 according to the embodiment are denoted by the same reference signs, and the description redundant with that of the first embodiment will be omitted.

As shown in FIG. 3, this converter system 101 differs from the converter system 1 according to the embodiment in that the converter system 101 is not provided with the first current sensor 19A and the second current sensor 19B (see FIG. 1), but is configured similarly in other respects. Since this converter system 101 is not provided with the first current sensor 19A and the second current sensor 19B, the electric current for driving the first contactor driving circuit 15A and the second contactor driving circuit 15B cannot be detected. In other words, the ECU 10 of the converter system 101 cannot detect the contactor drive current flowing from the first contactor driving circuit 15A or the second contactor driving circuit 15B to the electromagnetic coil 14 of the corresponding contactor 6.

Therefore, in this converter system 101, the ECU 10 cannot stop the operation of the converter 5 based on the contactor drive current detected during the operation of the converter 5. Thus, when the supply of electric power from one of the first contactor driving circuit 15A and the second contactor driving circuit 15B to the corresponding contactor 6 is stopped and an open failure in that the contactor 6 inadvertently opens occurs, the output voltage of the converter 5 may become excessive.

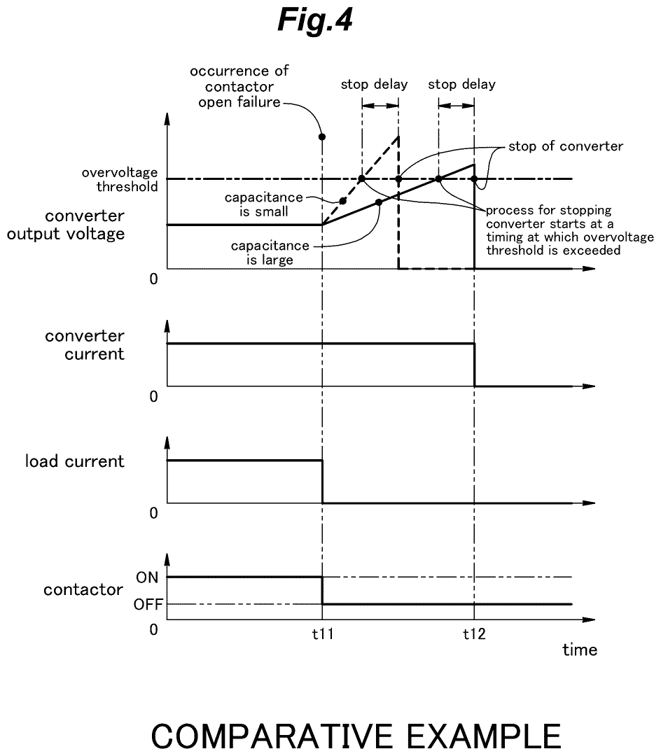

An operation of the converter system 101 in such a case will be described with reference to FIG. 4. FIG. 4 is a time chart showing the operation of the converter system 101 according to the comparative example. Note that the operation of the converter system 101 is the same regardless of whether an open failure occurs in the first contactor 6A or in the second contactor 6B and thus, in the following, description will be made of the contactor 6 without distinguishing between the first and second contactors. As shown in the drawing, an open failure in which the contactor 6 inadvertently opens occurs at a time point t11.

In a case where the capacitance of the capacitor provided in the converter 5 is small, the output voltage of the converter 5 increases rapidly and exceeds the overvoltage threshold, as shown in a broken line. When the output voltage exceeds the overvoltage threshold, the ECU 10 stops the operation of the converter 5. Namely, the ECU 10 starts a process for stopping the operation of the converter 5. As described above, there is a stop delay from the time point at which the output voltage of the converter 5 exceeds the overvoltage threshold to when the stopping process of the converter is actually completed, and therefore, the converter 5 continues to output the voltage during that time and the output voltage of the converter 5 becomes excessive. As a result, there is a possibility that electronic components including the capacitor may fail due to application of an excessive voltage.

On the other hand, in a case where the capacitance of the capacitor provided in the converter 5 is large, the output voltage of the converter 5 increases slowly, as shown in a solid line. In this case also, there is a stop delay from the time point at which the output voltage of the converter 5 exceeds the overvoltage threshold and the ECU 10 stops the operation of the converter 5 to when the stopping process of the converter 5 is completed. However, since the increase of the output voltage is slow, the increase of the voltage during the time period of the stop delay is smaller than the case where the capacitance of the capacitor is small. Therefore, the possibility that electronic components including the capacitor may fail is reduced. However, the time period from the time point t11 at which the open failure of the contactor 6 occurs to the time point t12 at which the converter 5 is stopped and the output voltage thereof is lowered is long, and in this case also, a voltage exceeding the overvoltage threshold is outputted.

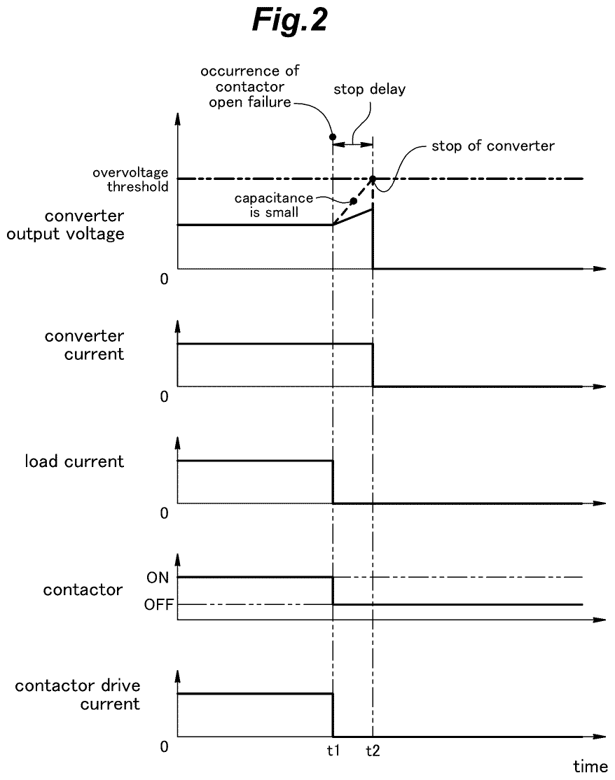

In contrast to this, the converter system 1 according to the present embodiment operates as follows. FIG. 2 is a time chart showing an operation of the converter system 1 according to the embodiment. Note that in the embodiment also, the operation of the converter system 1 is the same regardless of whether an open failure occurs in the first contactor 6A or in the second contactor 6B and thus, in the following, description will be made of the contactor 6 without distinguishing between the first and second contactors.

As shown in FIG. 2, at a time point t1, supply of electric power from the first contactor driving circuit 15A or the second contactor driving circuit 15B to the corresponding contactor 6 is stopped and an open failure in which the contactor 6 inadvertently opens occurs.

Since the ECU 10 is provided with the first current sensor 19A and the second current sensor 19B, the ECU 10 can detect the electric current outputted from each of the first contactor driving circuit 15A and the second contactor driving circuit 15B. In other words, the ECU 10 can detect the contactor drive current flowing from each of the first contactor driving circuit 15A and the second contactor driving circuit 15B to the electromagnetic coil 14 of the corresponding contactor 6. Thus, at the time point t1, the ECU 10 identifies the occurrence of the open failure of the contactor 6 and stops the operation of the converter 5.

In this case also, the converter 5 actually stops after a stop delay of a predetermined time from the time point t1 at which the ECU 10 identifies the occurrence of the open failure of the contactor 6 and stops the operation of the converter 5, and at a time point t2 at which the converter 5 actually stops, the output voltage of the converter 5 is lowered, as in the comparative example. On the other hand, the ECU 10 stops the operation of the converter 5 at the time point t1 at which the contactor drive current becomes undetected by the first current sensor 19A or the second current sensor 19B during the operation of the converter 5, and therefore, the increase of the output voltage of the converter 5 is suppressed compared to the comparative example in each of the cases where the capacitance of the capacitor is large (solid line) and where the capacitance of the capacitor is small (broken line). Thus, the possibility that electronic components including the capacitor may fail due to application of an excessive voltage is reduced.

As described above, since the ECU 10 stops the operation of the converter 5 at the time point t1 at which the contactor drive current becomes undetected by the current sensor 19 when electric current is outputted from the converter 5 to the load 3, namely, during the operation of the converter 5, the output voltage of the converter 5 is prevented from becoming excessive.

In the present embodiment, the first contactor 6A and the second contactor 6B are provided on the first power supply path 4, and the current sensor 19 includes the first current sensor 19A and the second current sensor 19B. When an open failure occurs in either contactor 6, the ECU 10 stops the operation of the converter 5 at the time point t1 at which the contactor drive current becomes undetected by the current sensor 19 corresponding to the contactor 6 in which the failure occurred. Therefore, the output voltage of the converter 5 is prevented from becoming excessive.

Concrete embodiments have been described in the foregoing, but the present invention can be modified in various ways without being limited to the above embodiments or modifications. For example, in the above embodiment, the load 3 is a traveling motor, an inverter, etc. of an automobile, but the load 3 may be another driving device of the automobile or a drive unit, electric equipment, etc. of a moving body other than the automobile, an industrial machine, or the like. Also, only one of the first contactor 6A and the second contactor 6B may be provided as the contactor 6. In this case, the ECU 10 only needs to be provided with the corresponding current sensor 19. Besides, the concrete structure, arrangement, number, or the like of each member or part may be appropriately changed without departing from the spirit of the present invention. Also, not all of the components shown in the foregoing embodiments are necessarily indispensable and they may be selectively adopted as appropriate.

1. A converter system, comprising:
a first power supply path connecting a power supply and a load;
a converter provided on the first power supply path;
a contactor provided between the converter and the load in the first power supply path, the contactor including a normally open movable contact for selectively establishing/interrupting the first power supply path and an electromagnetic coil for driving the movable contact;
a contactor driving circuit electrically connected to the electromagnetic coil to drive the contactor;
a current sensor for detecting a contactor drive current flowing from the contactor driving circuit to the electromagnetic coil; and
a controller configured to control the converter and to control the contactor driving circuit so as to supply electric power to the electromagnetic coil to close the contactor when the converter is in operation and so as to stop the electric power supply to the electromagnetic coil to open the contactor when the converter is stopped,
wherein the controller is configured to stop operation of the converter in a case where the contactor drive current becomes undetected by the current sensor during operation of the converter.

2. The converter system according to claim 1, wherein the contactor comprises a first contactor provided on a positive power line of the first power supply path and a second contactor provided on a negative power line of the first power supply path,
the contactor driving circuit comprises a first contactor driving circuit for driving the first contactor and a second contactor driving circuit for driving the second contactor, and
the current sensor comprises a first current sensor for detecting a contactor drive current flowing from the first contactor driving circuit to the electromagnetic coil of the first contactor and a second current sensor for detecting a contactor drive current flowing from the second contactor driving circuit to the electromagnetic coil of the second contactor.

3. A converter driving method in a converter system, wherein the converter system comprises:
a first power supply path connecting a power supply and a load;
a converter provided on the first power supply path;
a contactor provided between the converter and the load in the first power supply path, the contactor including a normally open movable contact for selectively establishing/interrupting the first power supply path and an electromagnetic coil for driving the movable contact;
a contactor driving circuit electrically connected to the electromagnetic coil to drive the contactor; and
a current sensor for detecting a contactor drive current flowing from the contactor driving circuit to the electromagnetic coil,
the converter driving method comprising:
controlling the contactor driving circuit so as to supply electric power to the electromagnetic coil to close the contactor when the converter is in operation and so as to stop the electric power supply to the electromagnetic coil to open the contactor when the converter is stopped; and
stopping operation of the converter in a case where the contactor drive current becomes undetected by the current sensor during operation of the converter.
